(19) United States
(12) Patent Application Publication
(10) Pub. No.: US 2023/0339597 A1
(43) Pub. Date: Oct. 26, 2023

(54) AIRCRAFT COMPRISING A WING ATTACHMENT FOR HIGH WINGS HAVING OBLIQUE CONNECTIONS

(71) Applicant: Airbus Operations SAS, TOULOUSE (FR)

(72) Inventor: Alistair FORBES, Toulouse (FR)

(21) Appl. No.: 18/301,738

(22) Filed: Apr. 17, 2023

(30) Foreign Application Priority Data
Apr. 25, 2022 (FR) 2203799

(51) Int. Cl. B64C 1/26

(52) U.S. Cl. CPC B64C 1/26

(57) ABSTRACT

An aircraft with a wing attachment connecting the wings and the fuselage of the aircraft and having first and second parts positioned on either side of the median longitudinal plane of the aircraft. Each first or second part comprises at least one vertical connection configured to transmit substantially vertical forces between one of the wings and the fuselage, and first and second oblique connections each having at least one first or second oblique rod that has a first end connected to the fuselage structure and a second end connected to the wing structure, the second ends of the first and second oblique rods being further apart than their first ends.

### CROSS-REFERENCES TO RELATED APPLICATIONS

This application claims the benefit of French Patent Application Number 2203799 filed on Apr. 25, 2022, the entire disclosure of which is incorporated herein by way of reference.

### FIELD OF THE INVENTION

The present application relates to an aircraft comprising a wing attachment for high wings having oblique connections.

### BACKGROUND OF THE INVENTION

According to an embodiment visible in FIG. 1, an aircraft comprises a fuselage 10, wings 12 extending on either side of the fuselage 10, and a wing attachment 14 connecting the fuselage 10 and the wings 12.

The fuselage 10 comprises a structure composed of approximately round or ovoid transverse reinforcements 16 (called frames) positioned in planes perpendicular to a longitudinal direction and longitudinal reinforcements (not shown) oriented approximately parallel to the longitudinal direction.

According to one configuration, the wings 12 are positioned in the upper part of the fuselage 10 and nested in the latter.

In line with the wings 12, the fuselage 10 comprises at least first and second frames 16, 16′ that are not continuous over the entire circumference of the fuselage 10 and each have right and left ends 16.1, 16.1′, 16.2, 16.2′. The wing attachment 14 comprises, for each frame 16, 16′, a reinforcing structure 18, 18′ connecting the right and left ends 16.1, 16.1′, 16.2, 16.2′ of the frames 16, 16′ to each other.

For each right or left end 16.1, 16.1′, 16.2, 16.2′ of each frame 16, 16′, the wing attachment 14 comprises at least one first connection 20 configured to react vertical forces, at least one second connection 22 configured to react longitudinal forces, and at least one third connection 24 configured to react transverse and horizontal forces, each of the first, second and third connections 20, 22, 24 connecting a first interface as one with the right or left end 16.1, 16.1′, 16.2, 16.2′ of the first or second frame 16, 16′ and a second interface as one with one of the wings 12.

Thus, the wing attachment 14 comprises twelve connections 20, 22, 24 and twenty-four interfaces. This large number of connections and interfaces leads to an increase in the complexity of the wing attachment 14, the structures of the fuselage 10 and the wings 12, and to an increase in the on-board mass.

### SUMMARY OF THE INVENTION

The present invention aims to remedy all or some of the drawbacks of the prior art.

To this end, the invention relates to an aircraft comprising a fuselage having a median longitudinal plane and a fuselage structure, wings extending on either side of the fuselage and having a wing structure, and a wing attachment connecting the wings and the fuselage and having first and second parts positioned on either side of the median longitudinal plane, each first or second part having at least one vertical connection configured to transmit substantially vertical forces between one of the wings and the fuselage.

According to the invention, each first or second part of the wing attachment comprises first and second oblique connections, the first oblique connection having at least one first oblique rod that has a first end connected to the fuselage structure and a second end connected to the wing structure, the first oblique rod forming, with a vertical plane perpendicular to the median longitudinal plane, an angle of between 30 and 60°, the second oblique connection having at least one second oblique rod that has a first end connected to the fuselage structure and a second end connected to the structure of the wing, the second oblique rod forming, with a vertical plane perpendicular to the median longitudinal plane, an angle of between 30 and 60°, the second ends of the first and second oblique rods being further apart than their first ends.

Providing oblique connections makes it possible to reduce the number of connections to eight and the number of interfaces to ten. Thus, the wing attachment can comprise six interfaces at the fuselage and four interfaces at the wings.

According to another feature, the first and second oblique rods are symmetric with respect to a vertical plane perpendicular to the median longitudinal plane. According to another feature, each first or second oblique rod forms, with a horizontal plane, an angle of greater than 0° and preferably less than 25°.

According to another feature, each first or second part of the wing attachment comprises an intermediate fuselage interface having a mounting plate connected to the fuselage structure, at least one first tab as one with the mounting plate and connected by a first articulation to the first oblique rod, and at least one second tab as one with the mounting plate and connected by a second articulation to the second oblique rod.

According to another feature, the fuselage structure comprises transverse reinforcements that are perpendicular to the median longitudinal plane and vertical, and longitudinal reinforcements connecting the transverse reinforcements. In addition, the mounting plate of the intermediate fuselage interface is connected to at least two longitudinal reinforcements connected at each of their ends to transverse reinforcements.

According to another feature, each first or second part of the wing attachment comprises first and second vertical connections, the first vertical connection having at least one first vertical rod that has a first end connected to the fuselage structure and a second end connected to the wing structure, the second vertical connection having at least one second vertical rod that has a first end connected to the fuselage structure and a second end connected to the wing structure.

According to another feature, each first or second part of the wing attachment comprises:
a front wing interface having a mounting plate connected to the wing structure, at least one first tab as one with the mounting plate and connected by a first articulation to the first vertical rod, and at least one second tab as one with the mounting plate and connected by an articulation to the first oblique rod,
a rear wing interface having a mounting plate connected to the wing structure, at least one first tab as one with the mounting plate and connected by a first articulation to the second vertical rod, and at least one second tab as one with the mounting plate and connected by a second articulation to the second oblique rod.

### BRIEF DESCRIPTION OF THE DRAWINGS

Other features and advantages will become apparent from the following description of the invention, which description is given solely by way of example, with reference to the appended drawings in which:

FIG. 1 is a schematic view of a wing attachment, illustrating an embodiment of the prior art,

FIG. 2 is a front view of an aircraft comprising a wing attachment for a high wing structure, illustrating an embodiment of the invention,

FIG. 3 is a side view of a part of the wing attachment visible in FIG. 2,

FIG. 4 is a perspective view of the wing attachment visible in FIGS. 2, and

FIG. 5 is a perspective view of a part of a wing attachment, illustrating an embodiment of the invention.

### DETAILED DESCRIPTION OF THE PREFERRED EMBODIMENTS

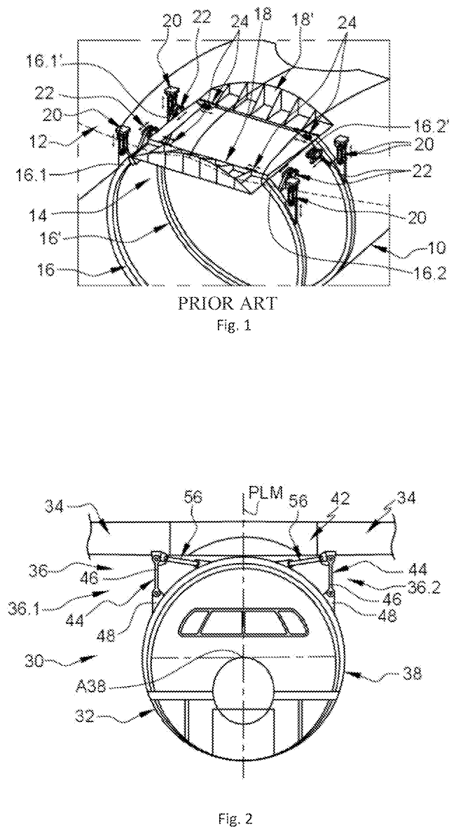

According to an embodiment visible in FIGS. 2 to 4, an aircraft 30 comprises a fuselage 32, wings 34 that extend on either side of the fuselage 32, positioned above the fuselage 32, and a wing attachment 36 connecting the wings 34 and the fuselage 32.

The fuselage 32 extends from front to rear and has at least one fuselage structure 38 that extends along a longitudinal axis A38. According to one configuration, the fuselage structure 38 comprises approximately round or ovoid transverse reinforcements 38.1, called frames, positioned in planes perpendicular to the longitudinal axis A38, and longitudinal reinforcements 38.2 approximately parallel to the longitudinal axis A38 that connect the transverse reinforcements 38.1. Of course, the invention is not limited to this configuration for the fuselage structure 38.

According to one embodiment, the wings 34 are continuous on either side of the fuselage 32. They have at least one wing structure 42 that extends in a wing direction substantially perpendicular to the longitudinal axis A38. According to one configuration, the wing structure 42 comprises spars that are substantially parallel to each other and to the wing direction, and ribs connected to the spars and positioned in planes substantially perpendicular to the wing direction. Of course, the invention is not limited to this configuration for the wing structure 42.

For the remainder of the description, a median longitudinal plane PLM is a vertical plane passing through the longitudinal axis A38. A longitudinal direction is substantially parallel to the longitudinal axis A38. A transverse and vertical direction is vertical and substantially perpendicular to the longitudinal axis A38. A transverse and horizontal direction is horizontal and substantially perpendicular to the longitudinal axis A38. A transverse plane is a plane perpendicular to the longitudinal direction.

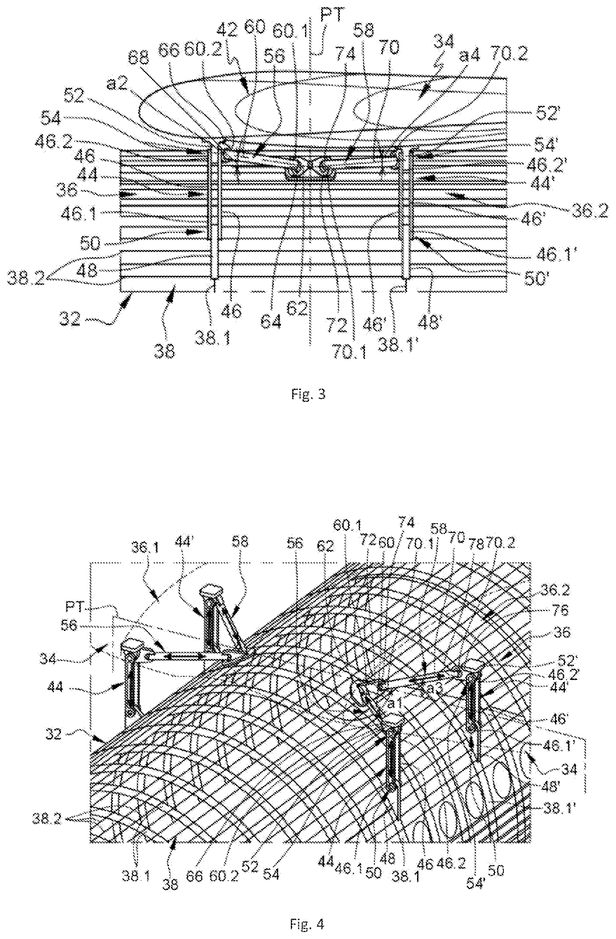

According to one arrangement, the fuselage 32 and the wings 34 are separate, as illustrated in FIGS. 2 and 3.

The wing attachment 36 comprises first and second parts 36.1, 36.2 positioned symmetrically on either side of the median longitudinal plane PLM. In the following, only the first part 36.1 of the wing attachment 36 is described, the second part 36.2 being symmetric to the first part 36.1 with respect to the median longitudinal plane PLM.

The first part 36.1 comprises at least one vertical connection 44 configured to transmit forces oriented vertically between one of the wings 34 and the fuselage 32. According to one configuration, the first part 36.1 comprises two vertical connections 44, 44′ spaced apart from one another and positioned in a single vertical plane parallel to the median longitudinal plane PLM.

According to one embodiment, each vertical connection 44, 44′ comprises at least one first vertical rod 46 oriented approximately vertically, a first fuselage interface 48 as one with the fuselage structure 38 and connected by an articulation 50 to a first end 46.1 of the first vertical rod 46, and a first wing interface 52 as one with the wing structure 42 and connected by an articulation 54 to a second end 46.2 of the first vertical rod 46.

According to one arrangement, each vertical connection 44, 44′ comprises two first vertical rods 46, 46′ connected, on the one hand, to the same first fuselage interface 48 by the same articulation 50 and, on the other hand, to the same first wing interface 52 by the same articulation 54. The two first rods are mutually parallel plates positioned in transverse planes.

Each articulation 50, 54 comprises at least one pivot axis parallel to the longitudinal direction. The pivot axes of the articulations 50, 54 are mutually parallel. According to one configuration, the articulations 50, 54 are ball-jointed.

In the presence of first and second vertical connections 44, 44′, the first vertical connection 44 comprises at least one first vertical rod 46 oriented approximately vertically, a first fuselage interface 48 as one with the fuselage structure 38 and connected by an articulation 50 to a first end 46.1 of the first vertical rod 46, and a first wing interface 52 as one with the wing structure 42 and connected by an articulation 54 to a second end 46.2 of the first vertical rod 46. In addition, the second vertical connection 44′ comprises at least one second vertical rod 46′ oriented approximately vertically, a second fuselage interface 48′ as one with the fuselage structure 38 and connected by an articulation 50′ to a first end 46.1′ of the second vertical rod 46′, and a second wing interface 52′ as one with the wing structure 42 and connected by an articulation 54′ to a second end 46.2′ of the second vertical rod 46′.

According to one configuration, each first or second fuselage interface 48, 48′ is positioned in line with a transverse reinforcement 38.1. In the presence of first and second vertical connections 44, 44′, the first fuselage interface 48 is positioned in line with a first transverse reinforcement 38.1 and the second fuselage interface 48′ is positioned in line with a second transverse reinforcement 38.1′ spaced apart from the first transverse reinforcement 38.1.

When the first or second vertical connection 44, 44′ comprises a single first vertical rod 46, the latter is positioned in the same transverse plane as the first or second transverse reinforcement 38.1, 38.1′ to which the first or second fuselage interface 48, 48′ is connected. When the first or second vertical connection 44, 44′ comprises two first vertical rods 46, the latter are positioned symmetrically with respect to the first or second transverse reinforcement 38.1, 38.1′ to which the first or second fuselage interface 48, 48′ is connected.

Each first or second part 36.1, 36.2 comprises first and second oblique connections 56, 58 each configured to transmit forces oriented in the longitudinal direction and/or in the transverse and horizontal direction between one of the wings 34 and the fuselage 32. According to one arrangement, the first and second oblique connections are symmetric with respect to a transverse plane.

According to one embodiment, the first oblique connection 56 comprises at least one first oblique rod 60, a third fuselage interface 62 as one with the fuselage structure 38 and connected by an articulation 64 to a first end 60.1 of the first oblique rod 60, and a third wing interface 66 as one with the wing structure 42 and connected by an articulation 68 to a second end 60.2 of the first oblique rod 60. According to one arrangement, viewed from above, the first oblique rod 60 forms, with a transverse plane PT (which is vertical and perpendicular to the median longitudinal plane PLM), an angle a1 of between 30 and 60°, the third wing interface 66 or the second end 60.2 of the first oblique rod 60 being offset towards the front of the aircraft with respect to the third fuselage interface 62 or the first end 60.1 of the first oblique rod 60. In a vertical plane, the first oblique rod 60 forms an angle a2 of greater than 0 and less than 25°, the third wing interface 66 or the second end 60.2 of the first oblique rod 60 being offset upwards with respect to the third fuselage interface 62 or the first end 60.1 of the first oblique rod 60. The second oblique connection 58 comprises at least one second oblique rod 70, a fourth fuselage interface 72 as one with the fuselage structure 38 and connected by an articulation 74 to a first end 70.1 of the second oblique rod 70, and a fourth wing interface 76 as one with the wing structure 42 and connected by an articulation 78 to a second end 70.2 of the second oblique rod 70. According to one arrangement, viewed from above, the second oblique rod 70 forms, with a transverse plane PT (which is vertical and perpendicular to the median longitudinal plane PLM), an angle a3 of between 30 and 60°, the fourth wing interface 76 or the second end 70.2 of the second oblique rod 70 being offset towards the rear of the aircraft with respect to the fourth fuselage interface 72 or the first end 70.1 of the second oblique rod 70. In a vertical plane, the second oblique rod 70 forms an angle a4 of greater than 0 and less than 25°, the fourth wing interface 76 or the second end 70.2 of the second oblique rod 70 being offset upwards with respect to the fourth fuselage interface 72 or the first end 70.1 of the second oblique rod 70.

According to this embodiment, the second ends 60.2, 70.2 of the first and second oblique rods 60, 70 are further apart than their first ends 60.1, 70.1 and offset upwards with respect to the first ends 60.1, 70.1.

According to one arrangement, the first and second oblique rods 60, 70 are symmetric with respect to a transverse and vertical plane, perpendicular to the median longitudinal plane PLM.

The first and second oblique rods 60, 70 form, on the one hand, the same angle with a transverse plane and, on the other hand, the same angle with a horizontal plane. In other words, the angles a1 and a3 are equal; the angles a2 and a4 are equal.

Each first or second oblique rod 60, 70 extends in a rod direction. According to one embodiment, each articulation 64, 68, 74, 78 comprises a pivot axis that is substantially perpendicular to the rod direction and substantially horizontal. According to one configuration, these articulations 64, 68, 74, 78 are ball-jointed.

According to one embodiment, the third and fourth fuselage interfaces 62, 72 form a single intermediate fuselage interface 80. The latter comprises a mounting plate 80.1 connected to the fuselage structure 38, at least one first tab 80.2 as one with the mounting plate 80.1 and connected by a first articulation 64 to the first oblique rod 60, and at least one second tab 80.3 as one with the mounting plate 80.1 and connected by a second articulation 74 to the second oblique rod 70.

The mounting plate and the first and second tabs 80.1, 80.2, 80.3 form a single component.

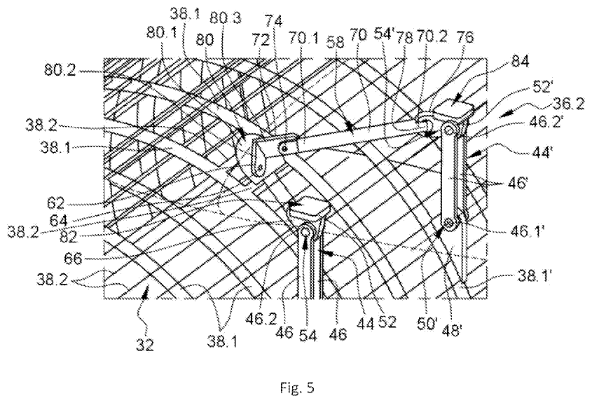

According to an arrangement visible in FIG. 5, the mounting plate 80.1 of the intermediate fuselage interface 80 is connected to at least two optionally reinforced longitudinal reinforcements 38.2, connected at each of their ends to transverse reinforcements 38.1 that can optionally be at least locally reinforced.

According to one embodiment, the first and third wing interfaces 52, 66 form a single front wing interface 82 comprising a mounting plate connected to the wing structure 42, at least one first tab as one with the mounting plate and connected by a first articulation 54 to the first vertical rod 46, and at least one second tab as one with the mounting plate and connected by an articulation 68 to the first oblique rod 60. The mounting plate and the first and second tabs of the front wing interface 84 form a single component.

According to one embodiment, the second and fourth wing interfaces 52′, 76 form a single rear wing interface 84 comprising a mounting plate connected to the wing structure 42, at least one first tab as one with the mounting plate and connected by a first articulation 54′ to the second vertical rod 46′, and at least one second tab as one with the mounting plate and connected by a second articulation 78 to the second oblique rod 70. The mounting plate and the first and second tabs of the rear wing interface 84 form a single component.

The fact that the wing attachment 36 comprises oblique connections 56, 58 makes it possible to reduce the number of connections to eight and the number of interfaces to ten. Thus, the wing attachment 36 comprises six interfaces at the fuselage and four interfaces at the wings. The invention makes it possible to simplify the wing attachment, the wings and the fuselage that are separate and continuous, and to reduce the on-board mass.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An aircraft comprising:
a fuselage having a median longitudinal plane and a fuselage structure,
wings extending on either side of the fuselage and having a wing structure, and
a wing attachment connecting the wings and the fuselage and having first and second parts positioned on either side of the median longitudinal plane, each first or second part having at least one vertical connection configured to transmit substantially vertical forces between one of the wings and the fuselage;
wherein each first or second part of the wing attachment comprises first and second oblique connections,
the first oblique connection having at least one first oblique rod that has a first end connected to the fuselage structure and a second end connected to the wing structure,
the at least one first oblique rod forming, with a vertical plane perpendicular to the median longitudinal plane, an angle of between 30 and 60°,
the second oblique connection having at least one second oblique rod that has a first end connected to the fuselage structure and a second end connected to the structure of the wing,
the at least one second oblique rod forming, with a vertical plane perpendicular to the median longitudinal plane, an angle of between 30 and 60°, and,
the second ends of the at least one first and second oblique rods being further apart than the respetive first ends of the at least one first and second oblique rods.

2. The aircraft according to claim 1, wherein the at least one first and second oblique rods are symmetric with respect to a vertical plane perpendicular to the median longitudinal plane.

3. The aircraft according to claim 1, wherein each first or second oblique rod forms, with a horizontal plane, an angle of greater than 0°.

4. The aircraft according to claim 3, wherein each first or second oblique rod forms, with a horizontal plane, an angle of less than 25°.

5. The aircraft according to claim 1, wherein each first or second part of the wing attachment comprises an intermediate fuselage interface having a mounting plate connected to the fuselage structure, at least one first tab as one with the mounting plate and connected by a first articulation to the at least one first oblique rod, and at least one second tab as one with the mounting plate and connected by a second articulation to the at least one second oblique rod.

6. The aircraft according to claim 5, wherein the fuselage structure comprises transverse reinforcements that are perpendicular to the median longitudinal plane and vertical, and longitudinal reinforcements connecting the transverse reinforcements, and wherein the mounting plate of the intermediate fuselage interface is connected to at least two longitudinal reinforcements connected at each of their ends to transverse reinforcements.

7. The aircraft according to claim 1, wherein each first or second part of the wing attachment comprises first and second vertical connections, the first vertical connection having at least one first vertical rod that has a first end connected to the fuselage structure and a second end connected to the wing structure, the second vertical connection having at least one second vertical rod that has a first end connected to the fuselage structure and a second end connected to the wing structure.

8. The aircraft according to claim 7, wherein each first or second part of the wing attachment comprises:
a front wing interface having a mounting plate connected to the wing structure, at least one first tab as one with the mounting plate and connected by a first articulation to the first vertical rod, and at least one second tab as one with the mounting plate and connected by an articulation to the at least one first oblique rod, a rear wing interface having a mounting plate connected to the wing structure, at least one first tab as one with the mounting plate and connected by a first articulation to the second vertical rod, and at least one second tab as one with the mounting plate and connected by a second articulation to the at least one second oblique rod.
